(19) United States
(12) Patent Application Publication
(10) Pub. No.: US 2008/0129730 A1
(43) Pub. Date: Jun. 5, 2008

(54) Method and apparatus of feature frame modeling for representing objects and shapes

(76) Inventor: Alyn P. Rockwood, Colorado Springs, CO (US)

Correspondence Address: Dr. Alyn P. Rockwood, 18375 Highland Estates Drive, Colorado Springs, CO, 80908-1568, US

(21) Appl. No.: 10/939,442

(22) Filed: Sep. 14, 2004

(51) Int. Cl. G06T 17/20

(52) U.S. Cl. 345/420

(57) ABSTRACT

Graphical objects are designed, manipulated or deduced by interpolating points, curves, surfaces or hyper surfaces through any number of input features, which are independently given curves, surfaces or hyper surfaces with associated derivative information. The interpolation is based on a new method for parameterizing discrete least squares. Said features may be configured in a topological arrangement specified by the user. The method also provides for patching different graphical objects together along general boundaries.

### RELATED APPLICATION

None.

### FEDERALLY SPONSORED RESEARCH

None related to this invention.

### SEQUENCE LISTING

None.

### FIELD OF THE INVENTION

The invention relates generally to the art of modeling surfaces and shapes of objects, and more particularly to computer implemented methods for designing shapes and representing shapes that fit given input. The invention can be applied to industries such as, but not limited to, internet advertising, animation, automotive, aerospace, geophysical, CAD/CAM, product design, and computer games.

### BACKGROUND OF THE INVENTION

In prior art, object shape is usually described or modified with a set of points or curves in space. Hoschek, Joseph and D. Lasser, Fundamentals of Computer Aided Geometric Design (1993) summarize many of these methods. One of the most common systems used to model and animate deformable objects is the B-spline computer modeling. In this method an array of points in space define a rectangular network of curves in space, which subsequently define a surface that passes smoothly through the curves. Movement of a point changes the shape of the curves in a region near the point, and this changes the shape of the surface near the point. This is the basic process by which a designer determines the shape of an object for such application areas as automobile styling, aerospace design, computer animation or product design. Other methods similar to the B-spline method include NURBS (Non-Uniform Rational B-Spline), Hermite, Bezier and Coons methods. In all these cases a rectangular network of curves is employed to define the surface shape. In all but the Coons method, a set of points is needed to define the curves. In the Coons method the curves may exist without prior point definition.

All of these methods may be thought of as deforming an elastic square to a malleable surface patch in the space of the object. These surface patches must be joined smoothly together at their margins in order to define an entire closed object. The need to maintain a rectangular network of curves and make them match at margins imposes a significant design obstacle in many instances for the designer. It is, for instance difficult to design a simple sphere with rectangular patches without some special handling at the poles, or overlapping some patches.

As also described in Hoschek, Joseph and D. Lasser, Fundamentals of Computer Aided Geometric Design (1993), a number of prior art methods interpolate points that are randomly positioned. These methods include the radial basis, thin plate spline, and Clough-Tocher methods. In these methods points are given randomly in space and a surface is defined to interpolate the points. Whereas, the previously described methods are devised to design objects, the aim of the latter methods is to reproduce an analytic function to represent the data that are acquired. One may, for example, want to deduce a surface from well log data in the oil exploration field. The wells are arbitrarily placed based on the best guesses of where oil may occur and also geographical convenience. The depth at which the wells intersect a different stratum can be connected with one interpolating surface, which is then usually close to the actual surface of the stratum and may help in more effective selection of future drilling sites. The state of the art methods are limited strictly to collections of point data and do not admit curves or other non-discrete objects as might occur where, for instance, continuous seismic data is mixed with well log data.

Another such exemplary conventional solution is called free form deformations (“FFDs”), see Thomas W. Sederberg et al., “Free-Form Deformation of Solid Geometric Models”, Dallas, vol. 20, No. 4, Aug. 1986, pp. 151-160.) Typically, FFDs are manipulated by editing of positions of control points in a uniform 3-D lattice imposed on a parallelepiped volume. While this technique yields some desirable mathematical properties, it can often be highly restrictive to a designer. For instance, with conventional FFDs, it is not practicable to create a deformation with a rotation effect centered around a single control point. To achieve such an effect with a conventional FFD, a higher resolution control lattice must typically be used; however, this too is undesirable as it complicates the deformation interface over the model.

One recent invention, which overcomes some of the problems described in the previous approaches, is described in Singh, Karan and E. Fiume, “Wires: A Geometric Deformation Technique,” Computer Graphics Proc., 1998, pp 405-414, and U.S. Pat. No. 6,204,860. A set of curves is input that may be in any configuration, not necessarily in a rectangular arrangement as most prior art. The curves do not even have to be attached. The curves may be deformed in space to design a rough shape with the curves. The set of curves is then blended by the prior art form known as Shepard's Method (see Hoschek). In this system the user inputs some curves in space that give a framework of curves defining the surface. The user may deform any of the curves, which subsequently deforms the surface and allows for design edit changes. The method of editing the curve depends on mapping the derivative at a point of the initial curve to a new position on the edited curve, and then fitting a new curve through the new position of the derivative. This method is insufficient because the computation is iterative and subject to singularities in computation. It cannot handle non-differentiable curves or single points, nor can it handle higher order derivative information.

This invention is a tool that overcomes the deficiencies of the previous methods by allowing the input of any point or parameterized curve in two or three dimensions in a freely designed configuration. The current invention overcomes deficiencies of previous methods in several ways. First, as the number of design curves increase the additional computation is increased linearly as opposed to most technology, which increases to the square of the number of design curves. Second, patch shape and number of points are arbitrary. Most current technology is highly constrained by connectivity, shape, and number of points. Third, the invention can display difficult, and previously impossible surfaces, such as non-differentiable surfaces like fractals. Fourth, the invention allows for the arbitrary movement of placed features. Currently, this cannot be done because of the inflexibility and instability of present technology. Fifth, the technology can mix points, lines, curves, surfaces, and hyper-surfaces without limitation. Sixth, there is no need for the features to be connected in any way, and they may overlap one another with no adverse effects. Seventh, current technology uses careful mapping to ensure that texture mapping boundaries match across patches. Since large surfaces can be described across multiple patches with the present invention, large texture maps can now be used, thereby addressing this problem. Eighth, currently animation is accomplished by carefully changing all motion in each frame; whereas, this invention is defined entirely by features and lines whereby all that needs to be moved for animation are the features and lines. Ninth, the surface can be manipulated not only by the features, but through changing functions so that the slopes, curves, surface normal, and derivatives can be controlled.

Therefore, this invention allows for far more flexible use in industries such as, but not limited to, Internet advertising, animation, automotive, aerospace, oil exploration, seismic activity, product design, and computer games.

### BRIEF SUMMARY OF THE INVENTION

The current invention is implemented on a computer graphics system. FIG. 1 shows the overall flow of the process. The inputs can be designed to be in any configuration and the inputs may be unattached to each other, they may self-intersect, or they may be aligned in any given connecting network. This is new and unique. FIG. 2 is an expanded view of the computational portion of FIG. 1 showing the order calculations. FIG. 3. is a schematic of the interactions of the inputs to create an output. FIG. 4 and FIG. 5 give examples of a point and curve configuration that is possible.

Any mixture of points, curves, surfaces, or possibly hyper surfaces, depending on the dimension of the shape, may be used as inputs. The inputs do not need to be of any particular continuity order. A curve, for example, may be continuous but non-differentiable as shown in FIG. 5.

This invention allows derivative information of any order, e.g., first, second, third, mixed partial derivatives etc., to be associated with each input of point, curve, surface and so forth. As an example, and without limiting the scope of the invention, partial derivatives may be input with a point in order to define a plane that passes through the point. Subsequently, the system will define a surface that passes through the point with a slope that agrees with the horizontal plane at the point. See FIG. 9. In another example, a curve may be input with both first and second derivative information so that the surface passes through the curve that agrees with slope and curvature defined by the derivatives. See FIG. 11.

The facility to define derivative information at inputs, especially at curves and surfaces, allows the design of shapes to be segmented into so-called patches. The patches can be made to join, for example, at boundary curves, which are curves that are shared by two or more patches. The patches then also share associated derivative information. Hence, two surfaces as seen in FIGS. 11 and 12 could join so that they share first partial derivatives along a common boundary curve, which implies that the surfaces also share common surface normals at the boundary. In many applications it is desirable to have a common curvature, as well. In applications involving fluid flow it even requires derivative of acceleration called jerk to match. This is a third directional derivative.

### BRIEF DESCRIPTION OF THE DRAWINGS

FIG. 1 is a flow chart of the features process.

FIG. 2 is a flowchart of the computation done for all features regardless of inputs.

FIG. 3 illustrates the relationship between the object space and parameter space.

FIGS. 4 and 5 depict a four-sided surface with and without an added point.

FIG. 6 depicts a non-differentiable fractal surface as displayed with features.

FIGS. 7 and 8 depict a terrain surface generated with features and the associated features.

FIGS. 9 and 10 depict a five-sided surface with varying slopes.

FIGS. 11 and 12 depict the patching of same surface with and without matched slopes.

FIGS. 13 and 14 depict a flower constructed with 4 circles the top circle has a sine variation.

### DETAILED DESCRIPTION OF THE INVENTION

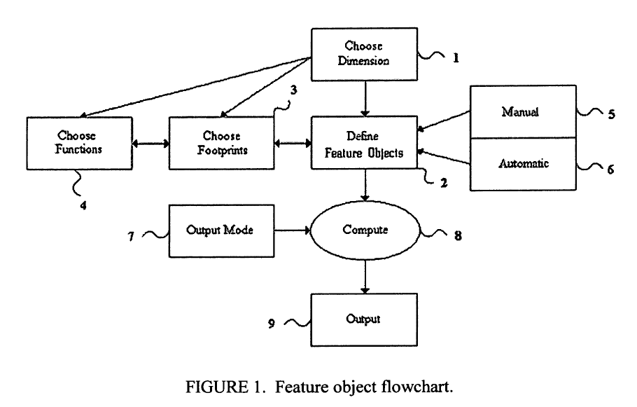

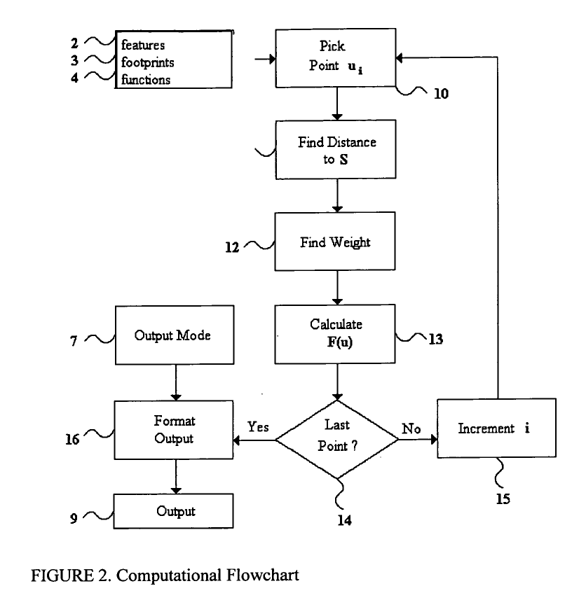

The present invention is applied to graphical objects that are designed, manipulated or deduced by interpolating a curve, surface or hyper surface through a plurality of input features that are independently given curves, surfaces or hyper surfaces with associated derivative information. In FIG. 1 the features do not require any specified configuration connectivity information. Step 1 allows the user to select a dimension within which to work. Step 2 allows the modeler to define the features by inputting points, lines, surfaces, or hyper surfaces. Step 3 defines the footprint for the features in parameter space where the dimension for the footprint depends on the dimension input by the user. Generally, the footprint dimension will be one less than the dimension of the output, but this does not have to be the case. Step 4 defines the functions that relate the footprints (parameter space) to the features and final outputs (object space). Steps 2-4 are not in a set order; they may occur in a different order. Steps 5-6 delineate the amount of control given to the user in Steps 2-4. All the features, footprint, and functions may be derived automatically. However, any combination from fully automated to fully manual may be selected dependent on the specific needs of the application. Step 7 is also dependent on the application, since the output is that of a function; we are not bound by conventional display methods. The output can be in any form desired; as such this output must be determined during pre-processing. The output can be chosen manually or automatically, given the needs of the specific application. Step 8 is the computation of the data collected pre-processing, this is described in more detail in FIG. 2. Step 9 is the culmination of all of the other steps in FIG. 1—providing an output for all of the input and computation of the features process.

Within the general description of the method as given in FIG. 1, new art is found but not limited to Step 8, where the method for interpolating points, curves, surfaces and hyper surfaces is computed. This is achieved by generalization of the Weighted Least Squares Method to a parametric form, which is diagrammed in FIG. 2. To do this, we begin with a Euclidean manifold of n dimensions. We let u be a point on the manifold with coordinates (u₁, u₂, . . . uₙ). This manifold is called parameter space and the point u is called the parameter. When the user gives an input called a feature (Step 2), it is defined on an m dimensional manifold called object space. It is a necessary step to define a corresponding input as a subset of parameter space, which is called the footprint (Step 3). The footprint is typically the same dimension as the feature, although not necessarily. Also given by the user is a function that maps a point on the footprint to a point on the feature (Step 4). Hence inputs come in triples: footprint, feature and function.

In a simple example, the footprint is a point in a two-dimensional space and the feature is a point in three-dimensional space given by adding a height value to the footprint. The addition of the height value also defines the function between the two points.

As seen in Steps 10 and 11 (FIG. 2), to further compute a shape with the invention, there must exist a method by which a distance d(u, S) between a point, u, in parameter space and a footprint, S, can be computed. The distance can be a very general function based on the point, u, and the footprint, S. In the previous simple example, the distance d(u, v) between u and the footprint v=(v₁, v₂) could be simply the Euclidean distance of

d(u,S)=[(u₁−u₂)²+(v₁−v₂)²]^{1/2} (1)

or it could be any so-called lₚ norm

d(u,S)=[(u₁−u₂)^{p}+(v₁−v₂)^{p}]^{1/p} (2)

where p is any positive real number; or it could be the max norm

d(u,S)=max(|u₁−u₂|,|u₁−u₂|) (3)

### There are many other distances that are known art between two points.

The next step, Step 12, is to compute a weighting function W (u, S) from the distance function d(u, S). The requirement of the weight function is that it grows to infinity as the distance function goes to zero, that is as the point u approaches the footprint. An obvious way to achieve this behavior is to define the weight function as the reciprocal of the distance function; thus W (u, S)=1/d(u, S). There are other ways to satisfy this constraint.

The last step, Step 13, in computing a point on the surface is to calculate the weighted least squares of the object points on the features, where the weighting functions are given as above as reciprocals to the distances.

Once calculated the value of the point on the object can be output in a number of graphical forms (Step 16). The user may for example choose (Step 9) to output the result as a polygonal mesh in which the evaluated points of the iterated loop containing Step 13 are vertices.

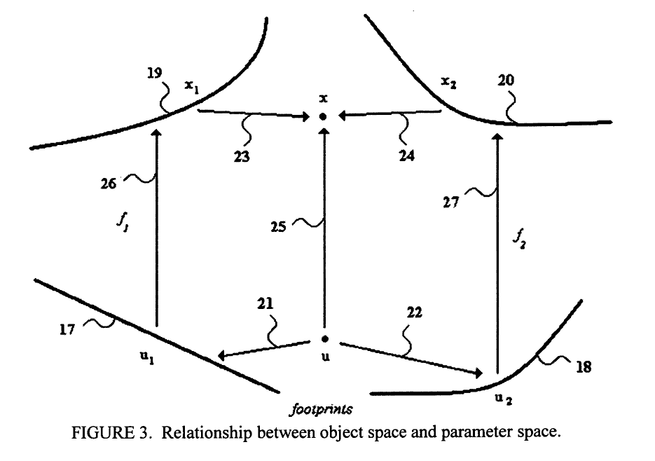

The behavior of F can be illustrated as follows (FIG. 3): if a point, u, in parameter space is close (21 and 22) to a footprint, Sₖ, (17 and 18) for some value k, then the weighting function Wₖ(U, Sₖ) will be large; all weighting functions where k is not equal to are insignificant in comparison. Therefore the contribution by fₖ(uₖ) (26 and 27) dominates, that is the value of F(u) (19 and 20) determined by 23 and 24 is close to fₖ(uₖ). The closer the parameter u is to the k^{th} footprint, the closer that the point on the object F (u) is to fₖ(uₖ). Item 25 shows the mapping of the point u to the point x.

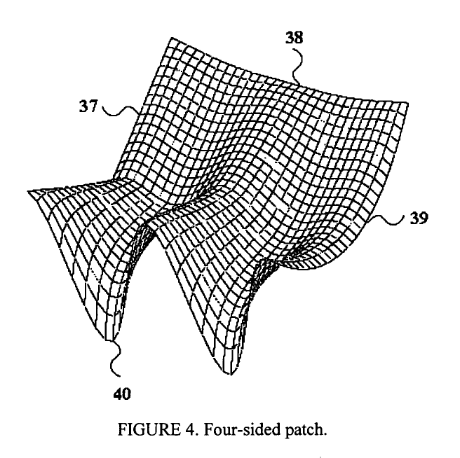

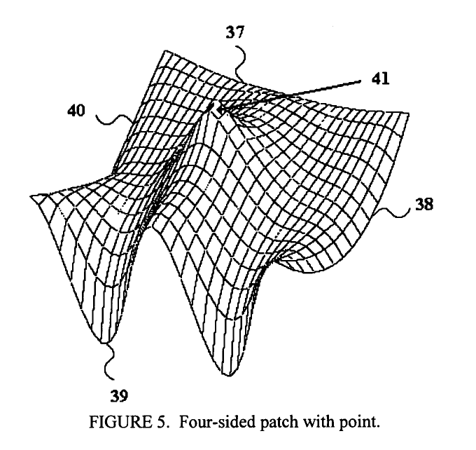

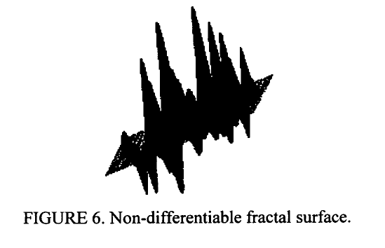

As examples: FIG. 4 demonstrates a surface, which interpolates four disparate feature curves. Feature curve 37 is an absolute value function; feature curve 38 is an exponential function; feature curve 39 is a parabolic curve; and feature curve 40 is a sinus function. The surface created by the invention passes through all four curves, In FIG. 5 a feature point 41 is added to the set of features and the surface interpolates the four curves and the point. No other prior art achieves this combination of curves and points.

The invention includes not only the parameterized Shepard's method with said features as described previously, but it also includes, as new art, the cases when said features include derivative information, such as, but not restricted to slope, surface normal, and curvature information. Any feature fₖ(uₖ) for a given index, k, can be, for example, a Taylor expansion with any number of derivative terms as is well-known art in the field; thus fₖ(u)=g(uᵤ)+c₁dg(uₖ)(u−uₖ)+ . . . .

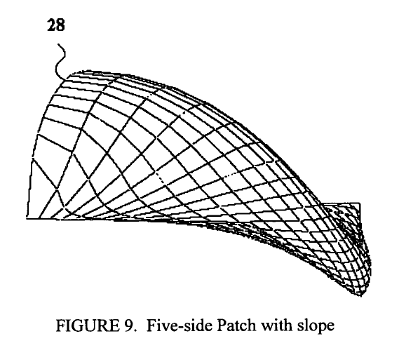

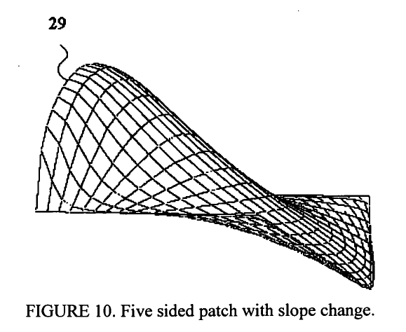

This forces the resulting surface to pass through the feature with matching derivatives at the feature. For example, a feature can comprise position and slope information and the surface passes through the feature with slope as specified. This is seen in an exemplary embodiment in FIG. 9 and FIG. 10. In FIG. 9, feature 28 is given with horizontal slope information that generates a surface that passes through the feature with horizontal slope. In FIG. 10, the magnitude of that slope information is decreased without changing the direction on feature 29.

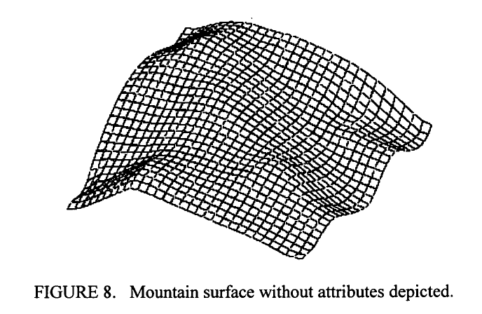

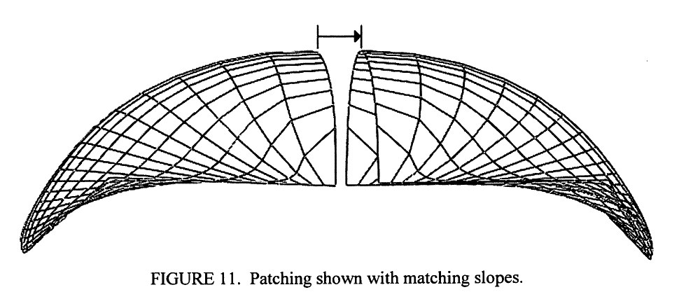

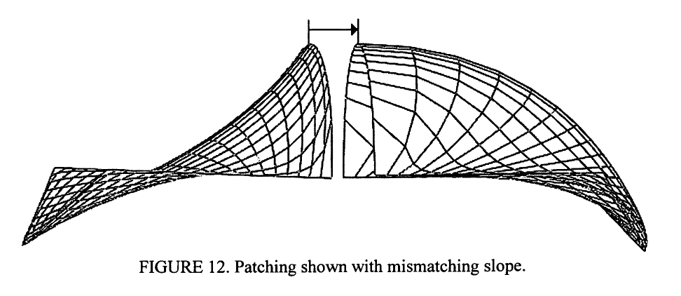

Allowing different surface pieces to be merged together along common boundaries, usually, but not always with common derivative information, further enhances the invention. Two separately defined surfaces may share common features and, thus, be merged along the feature. If the shared features have matching derivatives, then the merging will reflect that information. Hence, two surfaces may match in terms of position and slope, for example. Any number of separate surfaces may be joined along a number of common features in this invention. These may be used to build up a final graphical object. The procedure is called patching (see FIG. 11-8b).

The invention allows for the new use of current computer graphic texturing technology. The texture map can be applied to a specific patch or to the surface as a whole by applying the desired texture map in parameter space. By using the same functions that create the surface it is possible to accurately map the texture to object space.

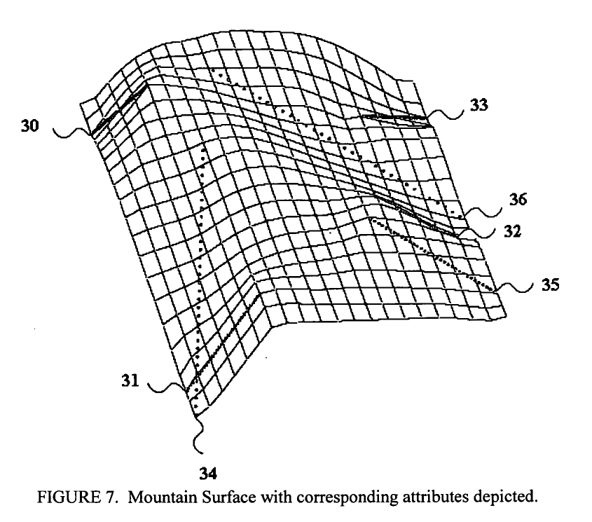

An exemplary use of features is demonstrated in FIGS. 7 and 8. FIG. 7 shows a surface in terrain generation. FIG. 8 shows the same surface with the features used to create the surface shown. Features labeled 30-33 show the features used to create peaks. By using features with greater positive values or slopes the surface is forced through the higher terrain regions. Features labeled 34-36 show the corresponding valleys. Using the same technique as with the peaks, but with flat values or slopes and in conjunction with the higher features a realistic terrain surface can be created and stored with a small number of features.

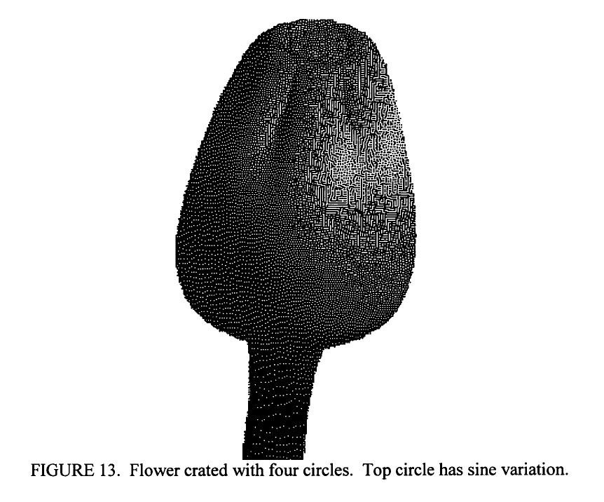

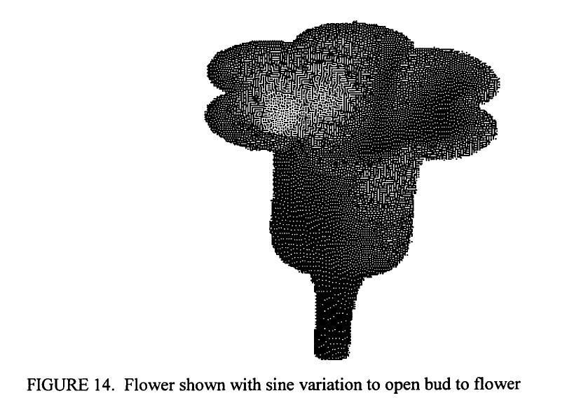

Another exemplary use is that shown in FIGS. 13 and 14. FIG. 13 shows a flower bud created by the use of four features in the shape of circles, with the top most having a sine variation applied to it. FIG. 14 shows the same illustration with the top most circle having a different sine variation in addition to vertical downward pointing slope information. In both of these figures the power of features is shown, by using a small number of features. It produces realistic looking surfaces. In addition, since the upper most feature is varied only in terms of a sine function it is a simple matter to animate between FIGS. 13 and 14. In this example the footprints are design on a cylindrical parameter domain. There is no restriction as to the footprint space. It may be planar, cylindrical, spherical or another shape that best suits the object being designed. Both planar and cylindrical shapes can be used for the flower in the figures, but cylindrical matches the flower's shape better and enables less costly distance calculations.

Allowing the features, footprints or functions or any combination to vary over time gives the invention great power and flexibility in animation. In FIGS. 13 and 14 all that is varied is the function describing the feature, yet it captures frame shots of a realistic animation. The flexibility of the invention, while shown by the pictures, is an indication of the new animation techniques encompassed by the invention.

What is claimed is:

1. A computer-implemented method for creating a graphical object, comprising steps (A1) through (A4) following: (A1) first defining a representation of a graphical object as including footprint objects and feature objects and feature functions, in which the said feature functions map from said footprints objects to said feature objects, and wherein said feature objects and said footprint objects are points, curves, surfaces or hyper surfaces in any dimension; (A2) second, evaluating for one or more given points in space, called domain points, a distance from each said domain point to each said footprint object and computing thereby the nearest points with respect to the distance on each said footprint object to each said domain point: (A3) for a collection of said nearest points of step A2 as input to the said feature functions, calculating as output a set of feature points all of which reside on or near the said feature objects; (A4) for the set of said feature points of step A3 as input compute an object function that generates as output a final point that then corresponds with each said domain point; said final point or final points representing a geometrical shape.

2. The method of claim 1 wherein said feature functions may contain derivative information, including but not limited to slope, surface normals, curvature and higher derivatives. A curve or surface which embodies the derivative information may be used as input.

3. The method of claim 1 wherein said feature objects are non-differentiable curves, including fractals.

4. The method of claim 1 to create a mesh of final points or polygons to represent a geometrical shape.

5. The method of claim 1 wherein said feature objects, said footprint objects or said feature functions are manipulated or changed to design or change said geometrical shape.

6. The method of claim 1 wherein the function of step (A4) is a generalized weighted least squares function as known in the art, and the said weights of said least squares function are computed as functions of the said distances in step (A2) of claim 1.

7. The method of claim 6 wherein the said generalized weighted least squares function is re-formulated for efficient computation, including the known art method of normal equations.

8. The method of claim 1 wherein any number of said geometrical shapes are matched or coincide along commonly shared feature objects, including: (A1) said feature objects given as input; (A2) said feature objects derived from existing geometrical shapes by segmenting said geometrical shapes at points, curves, surfaces or hyper surfaces; or (A3) said feature objects occur when said geometrical shapes are deleted or inserted along commonly shared said feature objects.

9. The method of claim 1 wherein a texture map or bitmap to said domain points can be correspondingly mapped wholly or partially to said geometrical shape.

10. The method of claim 8 wherein said texture map is varied on the geometrical shape by changing said feature objects, said footprint objects or said feature functions of claim 1.

11. The method of claim 1 wherein the said geometrical shape can be varied by changing said feature objects, said footprint objects or said feature functions with respect to another (time) variable to achieve the simulation of motion or to achieve animation.

12. The method of claim 1 wherein the said footprint space is planar, cylindrical, spherical, elliptic, conical or any of the known art representation of parametric domains.
